(19) United States
(12) Patent Application Publication
(10) Pub. No.: US 2026/0069505 A1
(43) Pub. Date: Mar. 12, 2026

(54) APPARATUS, SYSTEM, AND METHOD FOR AUTOMATED MEDICATION DISPENSING DEVICES

(71) Applicant: RXMATICS LLC, Sugar Land, TX (US)

(72) Inventors: Ben Shahbazi, Houston, TX (US); Ahmad Ahmadi, Sugar Land, TX (US)

(73) Assignee: RXMATICS LLC, Sugar Land, TX (US)

(21) Appl. No.: 19/303,098

(22) Filed: Aug. 18, 2025

Related U.S. Application Data
(63) Continuation of application No. 18/814,155, filed on Aug. 23, 2024, now Pat. No. 12,414,901.

(51) Int. Cl. A61J 7/00; A61G 12/00; A61J 1/03

(52) U.S. Cl. CPC A61J 7/0076; A61G 12/001; A61G 2203/20; A61J 1/03

(57) ABSTRACT

An apparatus, system, and method for improving the efficiency of medication distribution within a healthcare facility. In particular, the invention provides parallel dispensing of multiple medications from a network of modular, connected, and automated or semi-automated dispensing modules. The method is directed toward receiving and executing multiple collection, dispensing, and delivery orders simultaneously while operating in a healthcare facility. The invention may sort medications for storage and subsequent delivery while rapidly servicing a high volume of pharmacy orders. The invention includes visible, electronic marking of data which may indicate its stored medication and final destination. The system tracks each unit as it transports medication throughout the facility. The invention organizes the stored medication using removable packaging which allows identification and verification of dosage by the system while being easily accessed by staff.

### CROSS-REFERENCE TO RELATED APPLICATIONS

The present application is a continuation of U.S. application Ser. No. 18/814,155, filed on Aug. 23, 2024, the entire disclosure of which is incorporated herein by reference.

### FIELD OF THE INVENTION

The present invention relates generally to automated robotic systems. Specifically, the present invention is a device designed to securely deliver medicine within a medical or pharmaceutical facility along with a system and method for coordinating a series of such devices.

### BACKGROUND OF THE INVENTION

The process of dispensing and delivering medications within large healthcare facilities such as hospitals can be a complex and time-consuming process. Giving incorrect medications to a patient can hinder the patient's recovery or, worse, endanger their health. To avoid this, a number of safeguards are put in place to ensure accurate provision of these medicines. Unfortunately, these safeguards may inhibit the efficiency of medical facilities, particularly as the volume of patients scales upward.

In many hospitals, the central pharmacy distributes the dosages and quantity of medications a patient needs several times per day. This is generally done for each patient and nursing unit. Once the medication outlay has been determined for a period, a medication “pick list” is created where pharmacy staff will pick these medications from stock for dispensing to patients. This will often include repackaging and sorting of the medications. Without assistance from automation, these tasks are performed manually. These medications may be delivered directly to patients or stored in a designated cabinet for dispensing at the appropriate times, generally at the nursing station nearest to the patient.

These steps can produce a significant number of errors, due to the human aspect of manual picking tasks. Errors frequently originate from storing the medications at an incorrect location or picking medications from an incorrect location when dispensing to the patient. Further, due to the volume of medications handled by a pharmacy and the timing involved, they often fail to verify expiration date for a given dose at this stage in the process, resulting in some patients receiving expired medications. Other errors may occur due to mishandling and misidentifying one or more medications.

Some technological solutions have been introduced as a means to improve the accuracy and efficiency of the process. Automated dispensing robots are available to aid in the dispensing and intermediate storage of medications. Such robots can automatically acquire, verify, store, and distribute medications. These systems are, essentially, medication robots. One example of such a system is the Robot-RX® system, offered by Mckesson Automation, Inc. as described in patent documents U.S. Pat. Nos. 5,468,110A, 5,593,267A, and 5,880,443A. Another example is the system described in U.S. Pat. No. 11,078,018B2. Other technologies used for such systems include U.S. Pat. Nos. 8,036,773B2, 7,748,628B2, and US20070265730A1. These systems function similarly to one another.

In particular, the described systems operate using a small number of robotic arms to store and retrieve medications. This inhibits their ability to efficiently service a large, concurrent volume of medication provisions. This aspect means the system provides a slower fulfillment process than desired. Additionally, articulated mechanical components are particularly susceptible to electro-mechanical failures. Mechanical failures can completely arrest the fulfillment process until repaired. Further, if such an automated system fails then staff may not be able to quickly locate the medication for patients in a timely manner.

The present invention aims to address these shortcomings of manual processes and the existing automated systems. The invention provides an automated device that organizes, stores, and dispenses medications. The device includes a cart for mobility. The devices can be tracked within the hospital as the medications are delivered to their destinations. The system allows multiple robots to work in coordination with one another. In effect, thousands of medications may be distributed concurrently by the present invention, whereas the prior art would be significantly more limited due to reliance on the articulated robot movement. Additionally, the stored medication is able to be readily located and accessed should a unit become non-functional. These medications can be readily transferred between devices when there are technical issues with a given device. Because of this, the system may be utilized to issue a replacement unit for delivery and its modularity allows staff to quickly reissue any needed medicine from the troubled unit.

### BRIEF SUMMARY OF THE INVENTION

Embodiments of the present invention provide a mechanism to conduct concurrent storage, dispensing, and organization for a plurality of medications packaged in strips of connected punches stored in a plurality of small medication Dispensing Modules which are attached to Transport Modules, forming a unit. A plurality of units are, collectively, borne by a Transport Cart. Each unit operates independently from other units to dispense medication while delivered to a plurality of locations and patients in a healthcare facility, such as a hospital or hospice.

Dispensing Modules are assigned a particular medication and dosage. Dispensing Modules may have their medication loaded and unloaded when assigned or reassigned. A number of Dispensing Modules may be configured to fulfill medication orders for a plurality of specific medications and patients. Medications may include a variety of different specific drugs, dosages, packaging shapes or styles, packaging sizes, and/or material forms. These forms could include capsules, liquids, lozenges, powders, etc. Dispensing Modules may be equipped with a digital display that imparts information about the stored medication, such as its destination and other status information. Additionally, the Dispensing Module may include a scanning component, allowing it to efficiently store and access information about the medication being distributed, such as expiration dates or a manufacturer's recall of its contained medication.

Transport Modules may be interchangeable, allowing them to be attached to a number of different Dispensing Modules and/or carry a number of different medications as needs change within a service period, exchanging any contained medications if necessary. Additionally, Transport Modules may be equipped with a digital display that imparts information about the distribution process and other status information.

An operator may override the automated dispensing process and manually dispense medications from a Dispensing Module when needed. This feature allows medications to continue being delivered where there are system or network failures. This is achieved by the operator directly interacting with the Dispensing Module's onboard computer.

An infrastructural software for the system can allow tracking of medications, carts, and modules throughout their routes. This enables a centralized collection of data that can be utilized for record-keeping and troubleshooting. This data can be used to provide scheduling information to staff for when medication is available, other timing concerns, and location data for delivery. Staff can interact with the Dispensing Modules to access the medications and have access to information about the whereabouts of one or more modules should they need to enact contingencies or plan alongside other tasks. Additionally, the software can update the destination, schedule, or other information of one or more units according to changing needs. It also allows for a deployed unit to be recalled outside of its original schedule, returning unused/unneeded medications and prepared for redeployment.

### BRIEF DESCRIPTION OF THE DRAWINGS

FIG. 1A is a schematic of a Dispensing Module for an embodiment of the present invention.

FIG. 1B is a schematic of a Dispensing Module for an embodiment of the present invention, wherein the Dispensing Module has been detached from the Transport Module.

FIG. 2A is a schematic of a Medication Strip for an embodiment of the present invention.

FIG. 2B is a schematic of a Medication Strip for an embodiment of the present invention.

FIG. 3 is a schematic of a Dispensing Module for an embodiment of the present invention, wherein the inner drawer of the Dispensing Module has been pulled out of its casing.

FIG. 4A is a schematic of the front of a Dispensing Module for an embodiment of the present invention.

FIG. 4B is a schematic of the front of a Dispensing Module affixed to the Transport Module for an embodiment of the present invention.

FIG. 5 is a diagram visualizing a coordinated system of Dispensing Modules for an embodiment of the present invention.

FIG. 6 is a schematic visualizing a coordinated system of Dispensing Modules for an embodiment of the present invention, wherein the Dispensing Modules are attached to a corresponding Transport Module.

FIG. 7A is a schematic of a front view of a Transport Module for an embodiment of the present invention.

FIG. 7B is a schematic of a front view of a Transport Module with its access door opened for an embodiment of the present invention.

FIG. 7C is a schematic of a top view of a Transport Module with its access door opened for an embodiment of the present invention.

FIG. 8 is a schematic of a Transport Cart carrying the Dispensing Modules for an embodiment of the present invention.

FIG. 9 is an example Operator Interface for an embodiment of the present invention.

FIG. 10 is a flow diagram for the system work process in an embodiment of the present invention.

FIG. 11 is a logic diagram for the delivery process in an embodiment of the present invention.

### DETAIL DESCRIPTIONS OF THE INVENTION

All illustrations of the drawings are for the purpose of describing selected versions of the present invention and are not intended to limit the scope of the present invention.

For the purposes of this application, the term “Medication Pouch” refers to a unit dose of medication such as one or more oral solids, liquids, or powders of a given strength, form, or type that has been sealed in a package. Likewise, the term “Medication Strip” refers to a number of connected medication pouches containing the same medication. Multiple medication strips within the system may have the same medication, whether at the same or a different dosage. The term “Destination” refers to the location where dispensed medications are assigned to be delivered. A destination may be a patient, a nursing station, a medication cabinet, another pharmacy, or any related area in a facility. Facilities may cover a significant area and/or include multiple interconnected buildings. All storage media are presumed to be non-transitory storage media unless specifically described otherwise.

An embodiment of the apparatus comprises one or more Dispensing Modules, one or more Transport Modules, and a Transport Cart. A Transport Cart may be a wheeled push cart, though other means of mobile transport may fall within the scope of this invention. The Transport Cart is structured to carry the one or more Dispensing Modules and one or more Transport Modules.

Transport Modules serve as a temporary receptacle for dispensed medications. A Transport Module's structure comprises a cavity for holding dispensed medication, points for attachment to a Dispensing Module, and points for attachment to a Transport Cart. In some embodiments, the Transport Modules will further comprise a transmitter, a microprocessor, and an electronic display. In such embodiments, the transmitter may be configured to communicate with the attached Dispensing Module and display information about the dispensing of medications, such as availability for distribution by an operator and destination of the dispensed item(s). Other embodiments allow for the transmitter to be configured to communicate with other components of a related system, such as central software.

Dispensing Modules comprise a space to store a Medication Strip and a means to distribute Medication Pouches from that Medication Strip. The preferred embodiment further comprises sensors that enable the microprocessor to account for the quantity of Medication Pouches dispensed through the module. Some embodiments may enable modules to independently remove pouches from the strip though, otherwise, intact. Other embodiments may require pouches to be removed from the strip by a staff member or other operator. Distribution may be aided in some embodiments by a conveyor belt or operations similar to how merchandise is retrieved from vending machines. Some embodiments may also comprise display electronics to indicate information about the contents, destination, and/or schedule. Such electronics would be manually or automatically configurable to display the relevant information.

A microprocessor of the apparatus will be configured to manage the computing functions of a given embodiment, such as navigation and propulsion. The preferred embodiment would enable the microprocessor to communicate with an infrastructural management system through the one or more transmitters, enabling the apparatus to share pertinent data over a network. The preferred embodiment would further comprise electronic location hardware to indicate the position of the apparatus so that it can include that information in its reporting. Some embodiments may also comprise some quantity of non-transitory storage media to record data. Such embodiments may log data in lieu of or in addition to transmitting that data over the network. Embodiments may also configure the apparatus to broadcast alert states across additional channels to aid in identifying and locating an apparatus that is unable to continue its transport or dispensing functionality. Embodiments would allow the management of the apparatus to be distributed over multiple microprocessors. An example embodiment would utilize a microprocessor focused on the transport module and a number of microprocessors for the dispensing module, potentially up to one for each dispensing module. These microprocessors would be configured to coordinate the tasks of the apparatus, rather than relying on a single microprocessor.

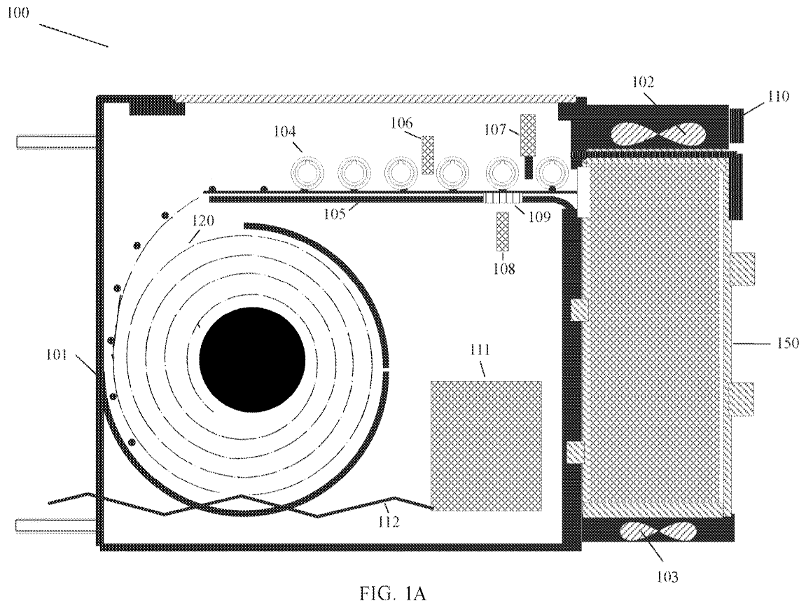

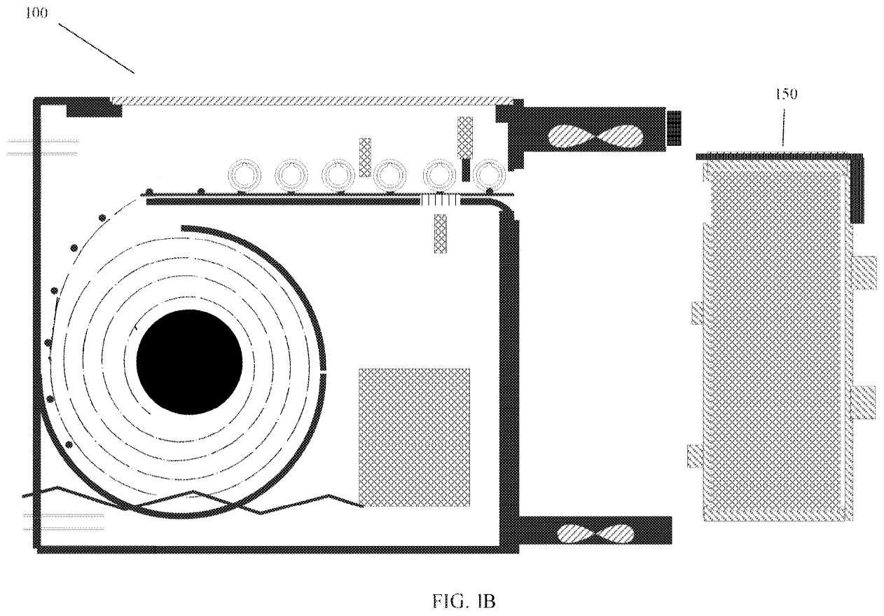

FIG. 1A and FIG. 1B demonstrate an embodiment of a Dispensing Module (100) on a side view. The module (100) comprises a drawer casing (101), a top fan (102), a bottom fan (103), an array of stepper or step motors (104), a guide bar (105), a top camera (106), a cutter (107), a bottom camera (108), a transparent opening (109), an electronic display (110), a microprocessing unit (111), and an electronic power and data connection (112). A rolled Medication Strip (120) is contained within a cavity of the dispensing module (100). For this embodiment, the casing (101) houses a medication strip (120) which unfurls as it distributes medication pouches. The stepper motors (104) pull the medication strip (120) along the guide bar (105) and the cutter (107) removes each individual medication pouch before it is distributed. The top (106) and bottom (108) cameras identify what medication passes through the distribution pathway. The bottom camera (108), specifically, views the distributed medication through the transparent opening (109) or window through the guide bar (105). These cameras may be configured to scan electronically relevant codes on the medication, which the microprocessing unit (111) can transmit and/or store. The casing (101) of the embodiment includes a panel to allow airflow through the top of the unit. Airflow is also facilitated by the top (102) and bottom fans (103) located adjacent to where the dispensing module (100) attaches to the transport module (150). The microprocessing unit (111) also occupies the interior structure of the dispensing module (100). This unit comprises a microprocessor and may further comprise a transmitter and non-transitory storage media. For this embodiment, the contained electronics are connected to a power source and adjoining systems by its power and data connection (112). FIG. 1B provides a view where the dispensing module (100) has been detached from transport module structure (150).

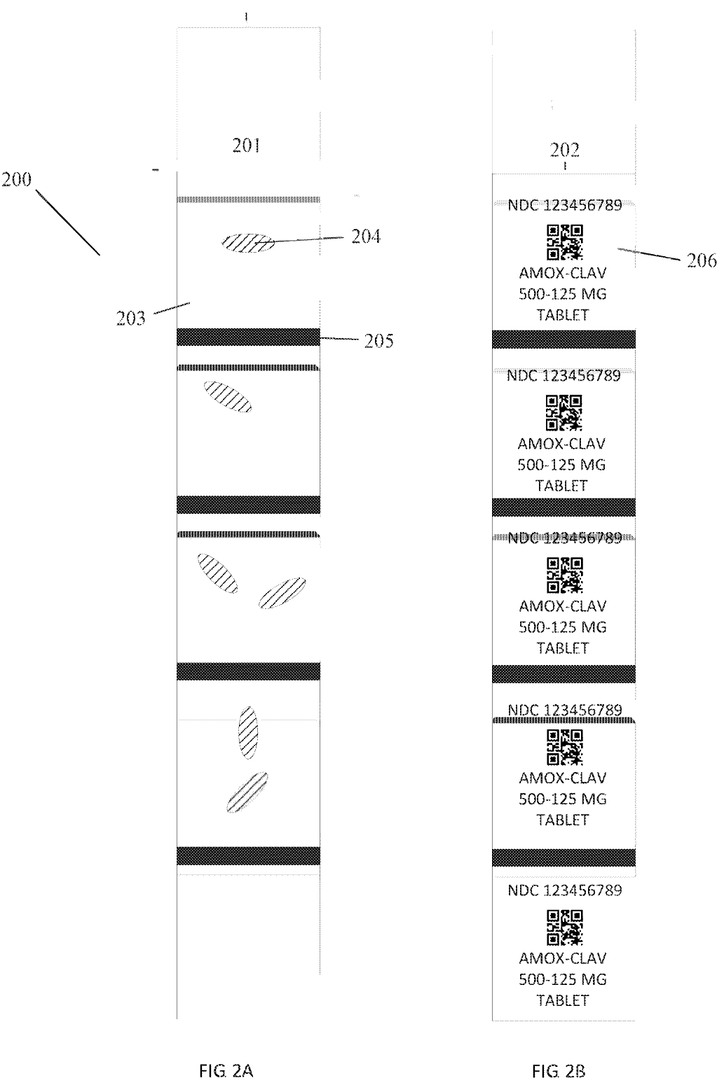

FIG. 2A and FIG. 2B are examples of a Medication Strip (200) for some embodiments of the invention. The strip (200) is displayed in two columns where the first column (201) indicates the top surface of the strip with a clear casing and the second column (202) indicates the bottom surface of the strip where opaque casing is used to convey data. The medications (204) are depicted as visible from the top side, each within an individual Medication Pouch (203) and separated by package separation marks (205). The opaque side indicates identifying information for the contained medication (206) such as an NDC number, QR Code, medication name, and dosage.

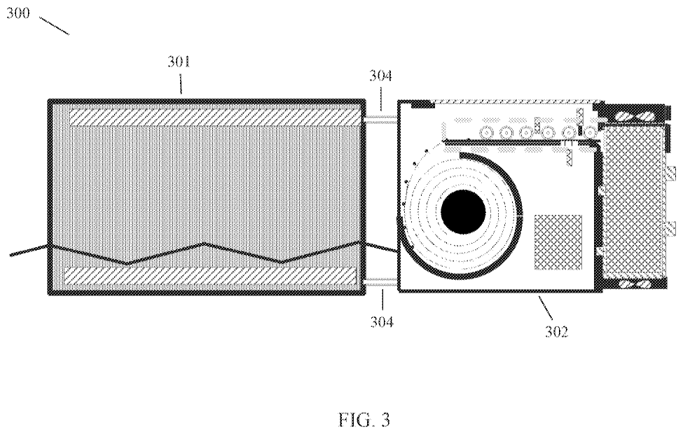

FIG. 3 demonstrates a side view where an embodiment of the Dispensing Module (300) has its inner drawer (302) pulled out from inside its casing (301). This is achieved by utilizing a rail structure (304) to allow the inner drawer (302) to slide outward.

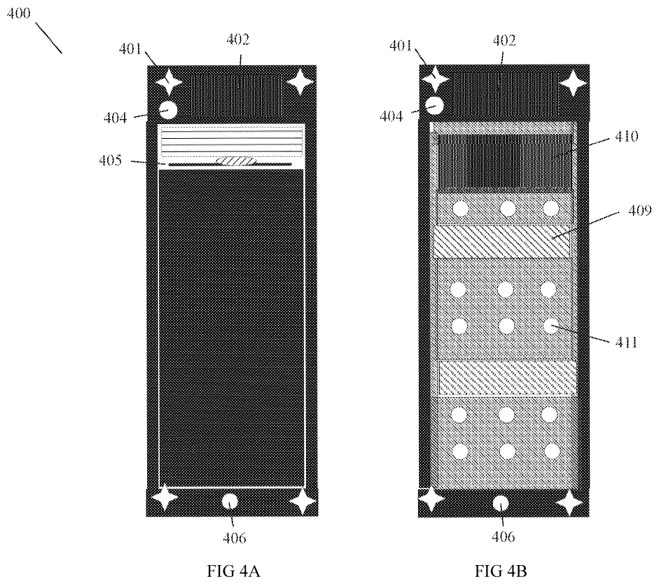

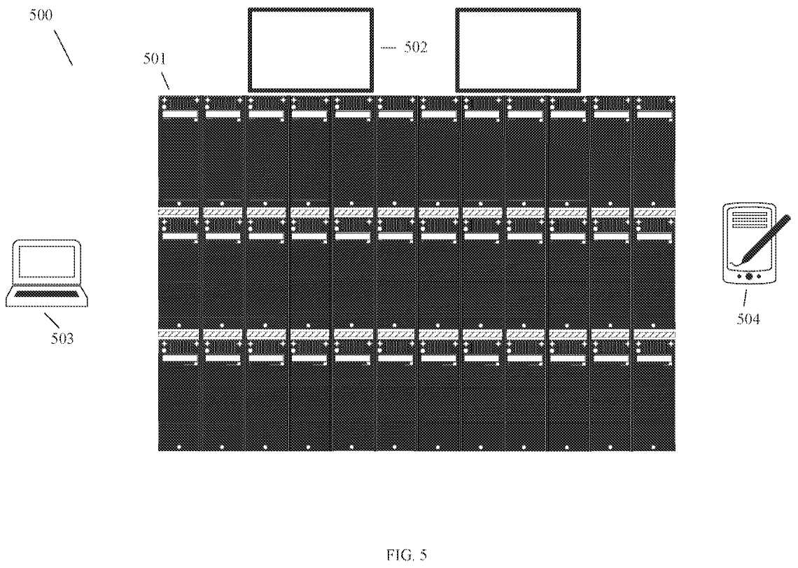

FIG. 4A and FIG. 4B are examples of a front view of an embodiment for Dispensing Modules (400). On each corner, a fastening point (401) designates where the transport module may be attached to the dispensing module (400). A digital display (402) is affixed to the face of the module's housing (400). An LED light (404) indicator is also present for this embodiment. Near the top of the module (400), we see access to the roller mechanism (405) where the module (400) dispenses medication pouches from the medication strip. Similarly, a manual dispensing access point (406) can be found toward the bottom of the module (400). The adjacent view demonstrates a dispensing module affixed to the transport module (409). A digital display (410) specific to the transport module is near the display (402) of the dispensing module. Improved airflow is facilitated through holes (411) in the dispensing module.

FIG. 5 is a visualization of the system (500) where multiple, individual dispensing modules (501) operate independently of each other and do not require the system to function. Such an embodiment may be conceived as a base where dispensing modules may be loaded and managed at the pharmacy. Alternately, the visualization may represent the dispensing modules (501) without regard to locality. This embodiment would include a number of electronic displays (502) where information can be presented for the system (500). The system may be accessed and managed through a fixed operator's device (503) and/or mobile operator's device (504).

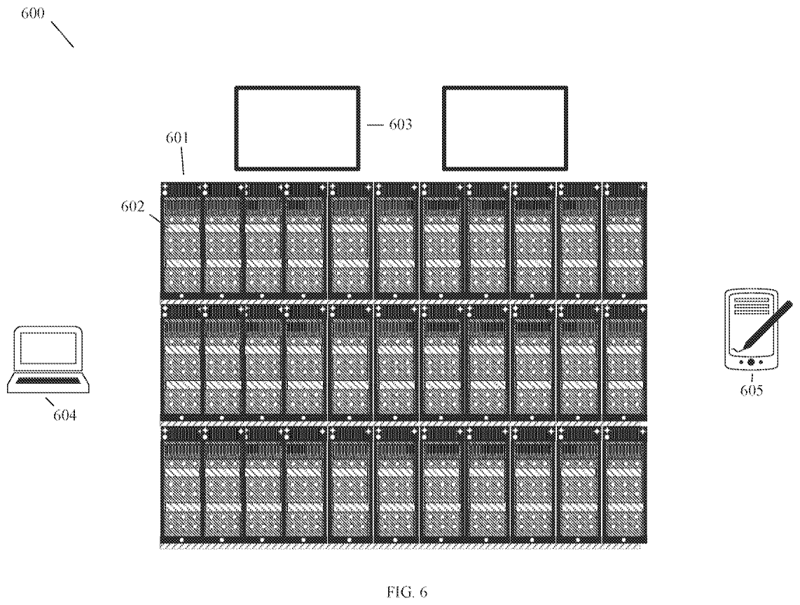

Similarly, FIG. 6 demonstrates the system (600) where the array of dispensing modules (601) are each affixed to a transport module (602). This embodiment may also comprise a number of electronic displays (603) where information can be presented for the system (600). For this figure, though shown collectively, the modules would be at multiple locations throughout the facility performing their delivery tasks. The system may be accessed and managed through a fixed operator's device (604) and/or mobile operator's device (605).

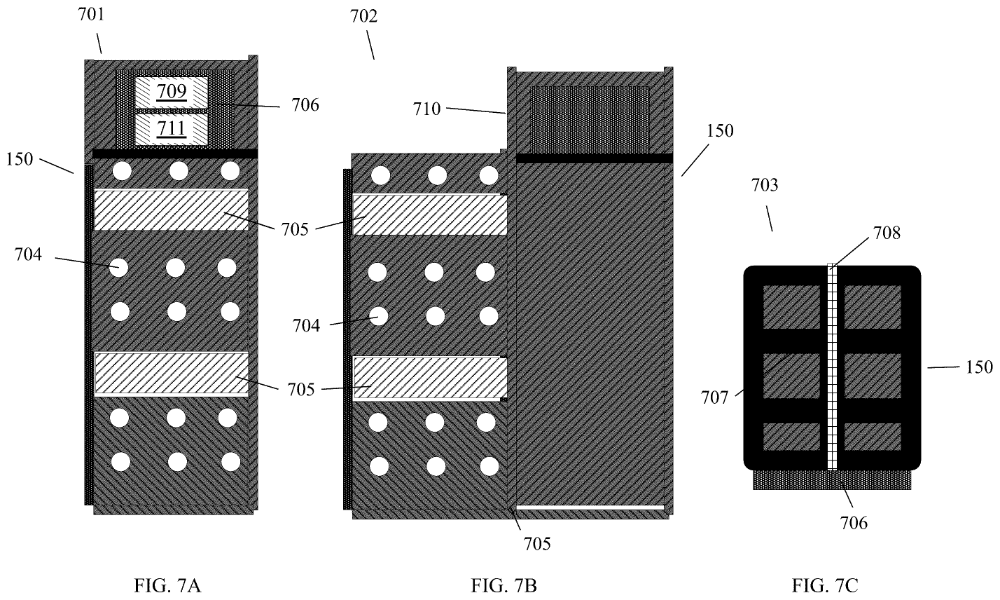

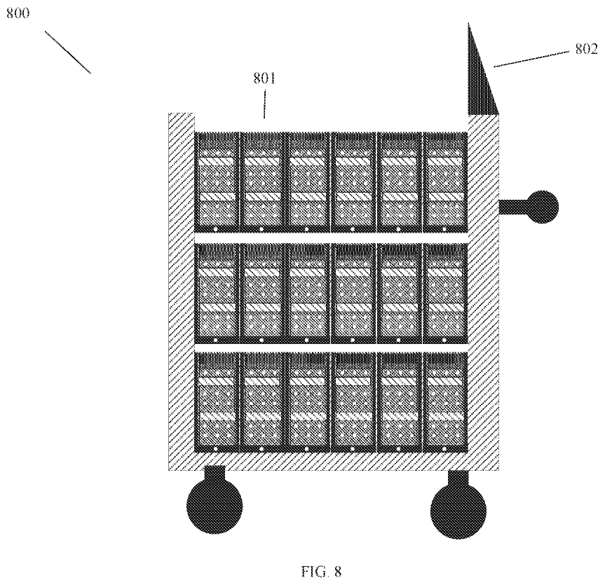

FIG. 7A, FIG. 7B are side views and FIG. 7C is a top view of an embodiment of the Transport Module (700) in multiple states. The first of these states are front views of the module in a closed state (701) in FIG. 7A and where its access door is opened (702) in FIG. 7B. Similarly, a top view of the module (703) is presented last in FIG. 7C. Airflow facilitating holes (704) are spaced across the module door. A locking mechanism (705) is affixed to the side of the door. On each view, we see an electronic display (706) while on the top view we see a handle (707) and wiring extended from the display (708).

FIG. 8 demonstrates the apparatus in the form of a transport cart (800). An array of dispensing modules (801) are affixed to the cart (800). The cart has its own screen (802) where the transport and individual dispensing module information can be displayed collectively, in addition to individual displays on the modules (801).

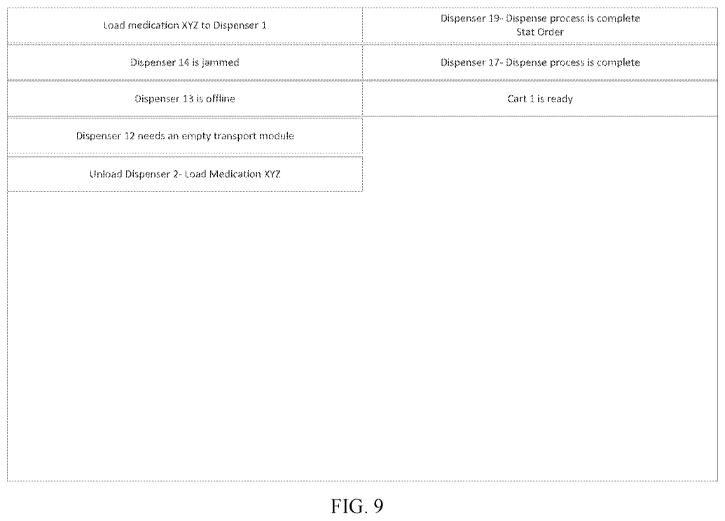

FIG. 9 demonstrates an exemplary embodiment of the system's operator dashboard (user interface). This embodiment of the interface displays the status information for deployed dispensing modules.

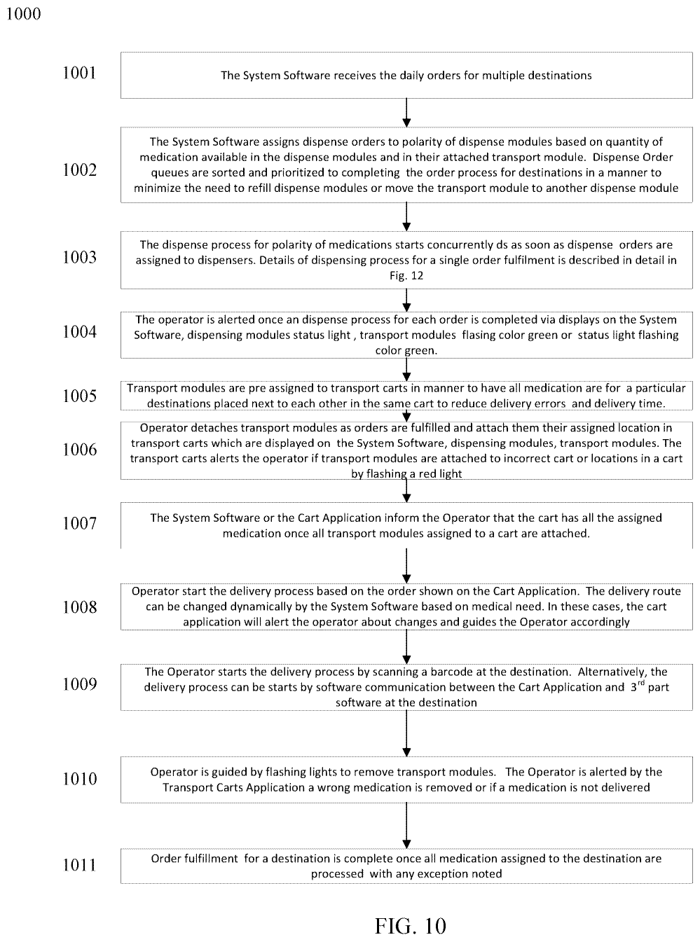

FIG. 10 is a flow diagram indicating an embodiment of the system work process for medication orders (1000). Orders are initially received (1001) to initiate one or more orders for medications. Those orders are optimized (1002) where a plurality of dispensing modules and the quantity of medication available within dispensing modules and their attached transport modules are assessed to be assigned for delivery. The software optimizes these assignments to minimize the need to refill dispensing modules and/or rearranging the attachment of modules. Once optimized, the system begins to assign dispensing modules (1003) as needed for dispensing. As the modules are prepared for delivery, the operator receives alerts through the system (1004) as to the status of each dispensing module. Data relating to the status of transport and dispensing modules are included in this information. Transport modules are arranged to be transported (1005) such that groups of medications going to the same destinations are kept together. Once a group of modules has been assigned and loaded, the system software indicates its readiness to be delivered (1006). The operator will then move any modules (1007) to the necessary group of modules, if necessary. Once assigned and loaded, the operator sends the robots/carts of grouped modules onto their delivery tasks (1008). The delivery route and schedule may be remotely adjusted through the system to account for medical needs or troubleshooting issues. At the delivery site, an operator would begin code scanning to identify and transport medications (1009). The modules would indicate when to remove from transport modules (1010). The modules would alert an operator and/or the system if the wrong medication is removed or a scheduled medication is not dispensed. A fulfilled order would then be registered as complete (1011).

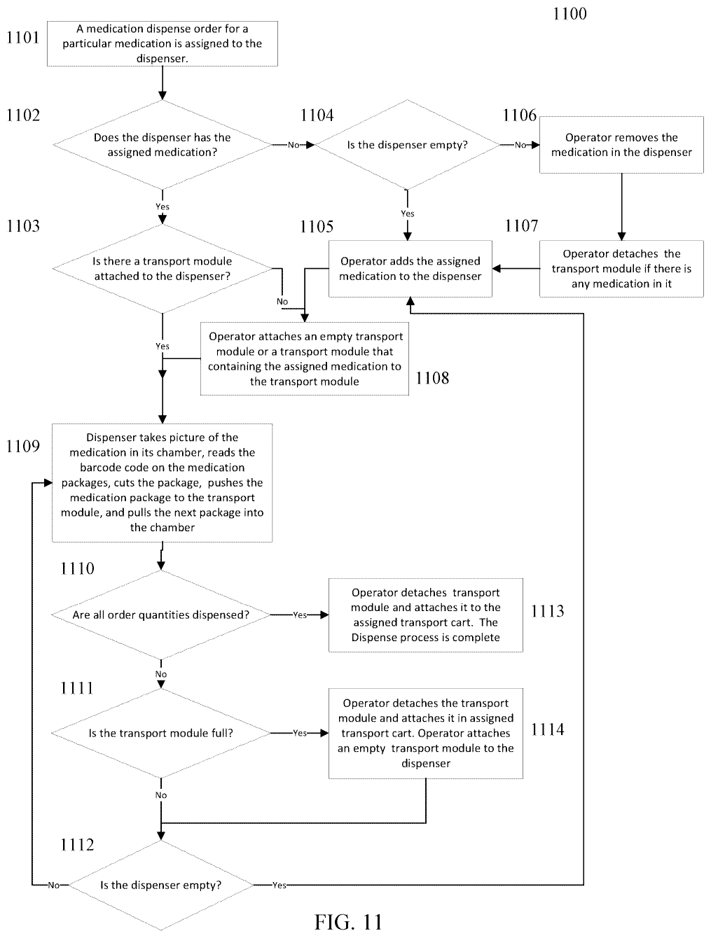

FIG. 11 presents a logic flow diagram for individual dispensing modules within an embodiment of the system (1100). This process begins when a dispensing module is assigned a delivery order (1101). The module checks whether it has the assigned medication and appropriate quantity (1102). If it does not, the module checks whether it is empty (1104). If it is not empty at this stage, the operator is alerted to remove the incorrect medication (1106) and detach any attached transport module (1107). Once empty, the operator installs the correct medication to the dispenser (1105). Once the module has the correct medication, it checks whether there is an attached transport module (1103). If it does not and/or after the correct medication is added to the dispenser, an empty transport module is attached to the dispenser (1108). The transport carts are then transported to their destination. At the delivery site, the module records the information of the medication being distributed, cuts the medication pouch from the medication strip, and dispenses the medication (1109). The module then indicates whether it has fulfilled all of its dispensing at the current destination (1110). If it has, then it would indicate for the operator to detach the transport module and attach it to the transport cart (1113). If there are medications that still need to be dispensed, the device would determine whether the transport module is full (1111). If it were, then the transport module would be replaced with an empty transport module (1114). If not, it would determine whether there is sufficient medication to dispense its next assigned order (1112). If there is insufficient medication present, it would return to the stage where an operator must add additional medication (1105). Otherwise, it would return to the stage where it dispenses medication (1108). This process would be repeated until a unit completes its delivery route.

Although the invention has been explained in relation to its preferred embodiment, it is to be understood that many other possible modifications and variations can be made without departing from the spirit and scope of the invention.

What is claimed is:

1. (canceled)

2. (canceled)

3. (canceled)

4. (canceled)

5. (canceled)

6. (canceled)

7. (canceled)

8. (canceled)

9. (canceled)

10. A system comprising:
an automated medication dispensing device of one or more medication pouches comprising:
one or more powered rollers to unfurl a held medication strip comprising the one or more medication pouches by pulling action;
one or more cutters to sever the one or more medication pouches from the held medication strip;
one or more sensors to record data from the one or more medications pouches as they are pulled;
an electronic display;
non-transitory storage media;
one or more microprocessors to receive information of any held or dispensed medication from an operator and the one or more sensors, store any received information on the non-transitory storage media, and display any received information on the electronic display; and
a dispensing module casing, wherein the dispensing module casing comprises a medication strip reel within its structure to unfurl as medication is dispensed.

11. The system of claim 10 further comprises at least a second automated medication dispensing device for synchronized parallel dispensing in a central pharmacy.

12. The system of claim 11 further comprises a remote software system to coordinate the synchronized parallel dispensing to minimize a need to refill the automated medication dispensing devices.

13. The system of claim 11 further comprises a remote software system to coordinate thousands of medication pouches distributed concurrently.

14. The system of claim 11, wherein the remote software system coordinates a transfer of the one or more medical pouches to the at least second medication dispensing device when the first automated medication dispensing device becomes non-functional.

15. The system of claim 10, wherein the one or more sensors comprise at least one scanner to scan encoded identifying information of the one or more medication pouches.

16. The system of claim 16, wherein the one or more medication pouches comprise a national drug code (NDC), QR code, medication name, dosage, lot number, and expiration date.

17. The system of claim 16, wherein the one or more medication pouches comprise expiration date and/or manufacturer's recall read by the one or more sensors and analyzed by the one or more microprocessors to prevent the automated medication dispensing device from dispensing expired and/or manufacturer's recalled one or more medication pouches.

18. The system of claim 10 further comprises a transport module attached to the automated medication dispensing device to store the one or more medication pouches, wherein the transport module is interchangeable, and wherein the transport module is equipped with a digital display that imparts information about distribution process and status information.

19. The system of claim 10 further comprises an infrastructural software to track the one or more medication pouches and the transport module throughout their routes and centralize collection of data for record-keeping and troubleshooting, and wherein the infrastructural software updates destination and schedule according to changing needs.

20. The system of claim 10, wherein the automated medication dispensing device is overridden by an operator interacting with the automated medication dispensing device directly when there is a failure that prevents the automated medication dispensing device from receiving dispensing orders.

21. A method comprising:
receiving an order of medications;
assigning dispensing orders of medications to automated medication dispensing devices based on a quantity of medications of each automated medication dispensing device;
dispensing medications concurrently by the automated medication dispensing devices; and
alerting an operator once the order of medications is completed.

22. The method of claim 21, further comprising alerting the operator via displays on the automated medication dispensing device, status light on the automated medication dispensing device, or any combination thereof.

23. The method of claim 21, further comprising:
dispensing the medication in a transport module; and
assigning the transport module to a transport cart based on destination grouping for delivery efficiency, wherein the destination is displayed on the automated medication dispensing device; the transport module, transport cart, or any combination thereof.

24. The method of claim 21, further comprising alerting the operator:
when the transport module is attached to an incorrect transport cart;
when the transport cart has all the ordered medications for an assigned destination; or
when a wrong medication is removed from the transport cart or when a medication is not delivered

[symbol]

25. The method of claim 21, further comprising delivering the medication based on the order of medications shown on the transport cart for delivery efficiency, and changing a delivery based on medical need and alerting the operator accordingly.

26. The method of claim 21, further comprising delivering the medication to its assigned destination by scanning a bar code for verification.

27. The method of claim 23, further comprising guiding the operator by flashing lights to remove transport modules assigned to a same destination from the transport cart.

28. A method comprising:
assigning an automated medication dispensing device to a medication, wherein the medication comprises one or more medication pouches held in a medication strip;
receiving a medication dispense order for the medication;
autonomously checking that the automated medication dispensing device has a quantity of the one or more medication pouches required to meet the medication dispense order;
autonomously checking that a transport module is attached to the automated medication dispensing device; and
delivering the medication by:
taking picture of the one or more medication pouches within the automated medication dispensing device;
reading a barcode on the one or more medication pouches;
cutting the one or more medication pouches from the medication strip to meet the medication dispense order; and
pushing the one or more medication pouches into the transport module.

29. The method of claim 28, further comprising alerting the operator when the transport module is full and when the automated medication dispensing device is empty.
